(19) United States
(12) Patent Application Publication
(10) Pub. No.: US 2001/0024951 A1
(43) Pub. Date: Sep. 27, 2001

(54) Apparatus and a method for providing operational status information between subscribers in a telecommunications network

(76) Inventors: Marten Rignell, Dalby (SE); Sten Minor, Lund (SE)

Correspondence Address: Stanley R. Moore, Esq., JENKENS & GILCHRIST, P.C., Suite 3200, 1445 Ross Avenue, Dallas, TX, 75202-2799, US

(21) Appl. No.: 09/813,665

(22) Filed: Mar. 20, 2001

(30) Foreign Application Priority Data
Mar. 22, 2000 (SE) 0000967-0
Mar. 14, 2001 (SE) 0100884-6

(51) Int. Cl. H04M 3/42

(52) U.S. Cl. 455/414; 455/567; 455/412; 455/417

(57) ABSTRACT

A telecommunication apparatus (10) has a radio interface (24, 43), a controller (44), a memory (45), an input device (46) and an output device (47). The controller provides a man-machine interface (48) to a user (49) through the input and output devices. The memory has a phonebook (40-42), which is accessed through the man-machine interface and stores a plurality of phonebook entries, where each entry represents a respective subscriber and an associated telephone number. For at least one of the phonebook entries, the phonebook (40-42) is capable of storing information (42) about an operational status of a respective subscriber. The controller (44) updates the operational status information of the at least one phonebook entry in response to status data, which are received through the radio interface (24, 43).

### TECHNICAL FIELD

Generally speaking, the present invention relates to the field of telecommunication and, more specifically, to a telecommunication apparatus of the type having a radio interface, a controller, a memory, and an input device and an output device together forming a man-machine interface. In more particular, the invention is directed at providing information to a user of the telecommunication apparatus about an operational status of another telecommunication apparatus.

The invention also relates to associated methods of providing aforesaid operational status information.

### PRIOR ART

Examples of a telecommunication apparatus as set out above are for instance a mobile or cellular telephone, a personal communicator, a portable digital assistant, a palmtop computer, etc.

For the rest of this document, reference is made to a mobile telephone, which is chosen to represent a telecommunication apparatus according to the invention. However, the invention shall in no way be limited to merely a mobile telephone.

In all areas of telecommunication there is a desire to improve the connectivity between users and increase the ratio of successful call attempts from one user to another. Moreover, there is a continuous need among individual users to obtain timely and accurate information about the accessibility and whereabouts of other related users, such as relatives, friends and business contacts. One way of improving the situation in a traditional public switched telephone network (PSTN) is to provide an answering machine in connection to the actual telephone or the telephone subscription. Another frequently used feature is call diversion, where incoming call attempts are diverted or redirected to another telephone or another subscription. These services are available in most mobile telecommunications systems as well.

In a mobile telecommunications system the accessibility of individual users is more dynamic and varying. Users of mobile telephones tend to switch their telephones off and on in order to preserve electric power or to avoid annoyance in public areas. Moreover, from time to time a user will be located out of reach for the mobile telecommunications system, i.e. too far away from the nearest base station, etc.

Bearing the above in mind, a mobile user will every now and then be unsuccessful in his/her call attempt to another user. In previously known mobile telecommunications systems there is no way for the caller, beforehand, to know whether or not the called party is currently accessible. The caller will simply have to keep on trying to reach an individual user, if the first call attempt was unsuccessful.

### SUMMARY OF THE INVENTION

It is an object of the present invention to improve the problem situation described above. It is a particular object of the invention to provide users of mobile telecommunications services with improved information about the momentary accessibility of other users of the mobile telecommunications system.

According to a preferred embodiment, the above objects are achieved by a telecommunication apparatus having a radio interface, a controller, a memory, an input device and an output device, where the controller provides a man-machine interface to a user through the input and output devices and where the memory comprises a phonebook, which is accessible through the man-machine interface and stores a plurality of phonebook entries, each of which represents a respective subscriber and an associated telephone number, by providing the phonebook with a capability of storing, for at least one of the phonebook entries, information about an operational status of a respective subscriber, and by arranging the controller to update the operational status information of the at least one phonebook entry in response to status data, which are received through the radio interface.

The above objects are also achieved through a method of operating a telecommunications network involving a plurality of subscribers of mobile telecommunications services, by providing an option for an individual subscriber to select at least one other subscriber, keeping record of the selected subscriber, determining an operational status of the selected subscriber and transmitting the determined operational status to the individual subscriber.

The preferred embodiment of the present invention provides improved service for a user of a mobile telephone in a mobile telecommunications system by offering the user online information about the momentary accessibility of other users or subscribers in the mobile telecommunications system. The statue information is preferably transmitted as a digital message, using SMS, USSD or any other available data carrier, to the user's mobile telephone, where a phonebook is updated to reflect the received status information.

The user of the mobile telephone may subscribe to this kind of information service about a selected plurality of individual users or subscribers in the mobile telecommunications system. As soon as the operational status of any of these selected subscribers changes from e.g. busy (i.e. unable to answer an incoming call attempt) to available, the changed status information will be transmitted to the subscribing user, which will be alerted about the change in accessibility in an appropriate way. Preferably, the status information about the selected subscribers is indicated as a separate information field or tag in the phonebook stored in the mobile telephone. In this way the user of the mobile telephone may take a quick look in his/her phonebook and accordingly determine whether or not the desired subscriber is available for answering a telephone call.

According to an alternative embodiment, instead of using operational status information from the telecommunications network itself, a first telecommunication apparatus is adapted to request the desired operational status information directly from a second telecommunication apparatus through bidirectional communication of digital messages, such as SMS or MMS, between the two telecommunication apparatuses. Thus, according to this alternative embodiment, the telecommunication apparatuses operate in a “peer-to-peer” manner and uses the telecommunications network only as an intermediate means for performing the exchange of digital messages between the two telecommunication apparatuses so as to determine their operational status.

Other objects, features and advantages of the present invention will appear from the following detailed disclosure of preferred and alternative embodiments, from the appended claims as well as from the drawings.

### BRIEF DESCRIPTION OF THE DRAWINGS

Preferred and alternative embodiments of the present invention will now be described in more detail with reference to the attached drawings, in which:

FIG. 1 is a schematic overall diagram of a mobile telecommunications system, where the apparatus and method according to the present invention may be applied,

FIG. 2 is a schematic front view of a mobile telephone,

FIG. 3 is a schematic block diagram of essential components, in the context of the preferred embodiment, of the mobile telephone shown in FIG. 2,

FIG. 4 illustrates a display of the mobile telephone shown in FIGS. 2 and 3, and an electronic phonebook presented thereon,

FIG. 5 is a schematic diagram of essential parts of the mobile telecommunications system according to the preferred embodiment,

FIG. 6 illustrates the display and the phonebook from FIG. 4, however extended by additional information according to the preferred embodiment,

FIG. 7 is a flow chart, which illustrates the basic steps of the method according to the preferred embodiment.

FIG. 8 is a schematic block diagram of the essential components of a telecommunication apparatus according to an alternative embodiment,

FIG. 9 is a schematic illustration of the way in which the alternative embodiment operates,

FIG. 10 is a more detailed illustration of the way in which the alternative embodiment operates, and

FIG. 11 is a schematic block diagram of important parts of the alternative embodiment.

### DETAILED DISCLOSURE

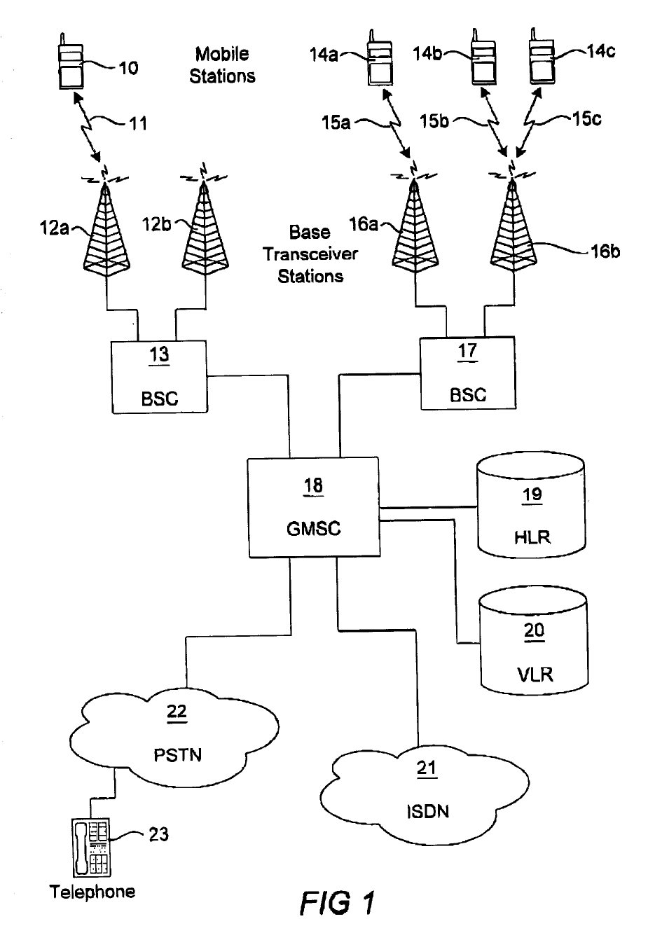

FIG. 1 illustrates a mobile telecommunications system, in which the apparatus and method according to the present invention may be applied. The illustration is an exemplifying GSM system, and the invention will be described in the following with reference to this system. However, it is to be understood that the invention may equally well be applied also to other systems for mobile telecommunications, which are not specifically disclosed herein.

The mobile telecommunications system of FIG. 1 provides mobile telecommunications services to a plurality of users via respective mobile telephones or mobile stations 10, 14a, 14b, 14c. The mobile telephones are given access to the mobile telecommunications system by wireless links 11, 15a, 15b, 15c to a plurality of base transceiver stations 12a, 12b, 16a, 16b. Each of the base transceiver stations is arranged to cover an individual cell in order to handle incoming and outgoing calls to and from mobile stations within the cell.

The base transceiver stations 12a-b, 16a-b are connected to base station controllers 13, 17, which in turn are connected to a switching center 18 (GMSC, “Gateway Mobile services Switching Center”). The switching center 18 is fundamental to the exemplified GSM system and is responsible for carrying out various switching operations of mobile telephony. The switching center 18 acts as a gateway to other telephone networks, such as a public switched telephone network (PSTN) 22 as well as an integrated services digital network (ISDN) 21. Hence, users of the mobile stations 10, 14a-14c may establish a telephone communication link with users 23 of the other telephone networks 21, 22.

To assist in its switching task the switching center 18 is connected to a home database 19 (HLR, “Home Location Register”) and a visitor database 20 (VLR, “Visitor Location Register”). The home database 19 stores information about a plurality of subscribers of mobile telecommunications services provided by the system of FIG. 1. The visitor database 20 stores information about all “foreign” subscribers, which are temporarily located within the service area of the switching center 1.

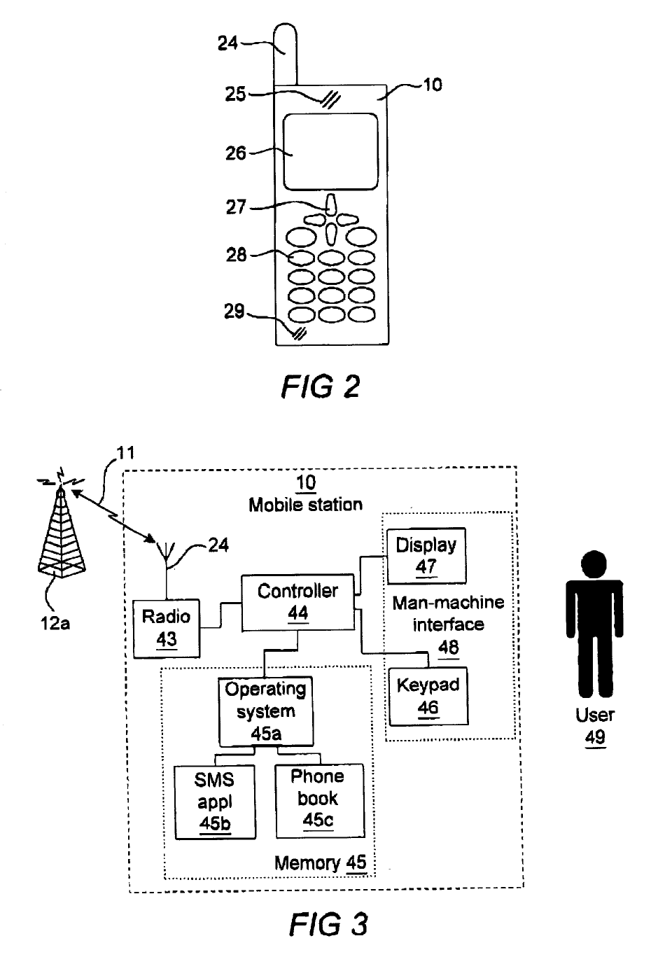

FIG. 2 illustrates the mobile telephone 10 in FIG. 1 in more detail. As is well known in the technical field, the mobile telephone 10 comprises an antenna 24, a loudspeaker 25, a display 26, a first plurality of navigation keys 27, a second plurality of alphanumeric keys 28, and a microphone 29.

FIG. 3 illustrates the most important internal components, within the context of the preferred embodiment, of the mobile telephone 10. A controller 44 is responsible for the overall operation of the mobile telephone 10 and is preferably implemented by any commercially available CPU (“Central Processing Unit”), DSP (“Digital Signal Processor”) or any other electronic programmable logic device. The controller 44 is coupled to a radio interface 24, 43, comprising the antenna 24 and radio circuitry 43. The radio interface 24, 43 is responsible for establishing and maintaining the wireless link 11 to the base transceiver station 12a. As is well known to a man skilled in the art, the radio circuitry 43 comprises a series of analog and digital electronic components, which together form a radio receiver and transmitter. The radio circuitry 43 comprises, i.a., bandpass filters, amplifiers, mixers, local oscillators, lowpass filters, AD converters, etc.

The controller 44 is also connected to an electronic memory 45, such as a RAM memory, a ROM memory, an EEPROM memory, a flash memory, or any combination thereof. The memory 45 is used for various purposes by the controller 44, one of them being for storing data and program instructions, which form a man-machine interface 48. The man-machine interface 48 also involves a keypad 46 (corresponding to the keys 27, 28 in FIG. 2) and a display 47 (corresponding to the display 26 in FIG. 2). A user 49 of the mobile telephone 10 will operate the telephone through the man-machine interface 49, an is well known per se.

Additionally, the memory 45 contains an operating system 45a for the mobile station 10. Together with the controller 44, the operating system 45a controls the man-machine interface 48, the operation of the radio circuitry 43 as well as various application programs, such as an SMS application 45b (SMS—“Short Messages Services”).

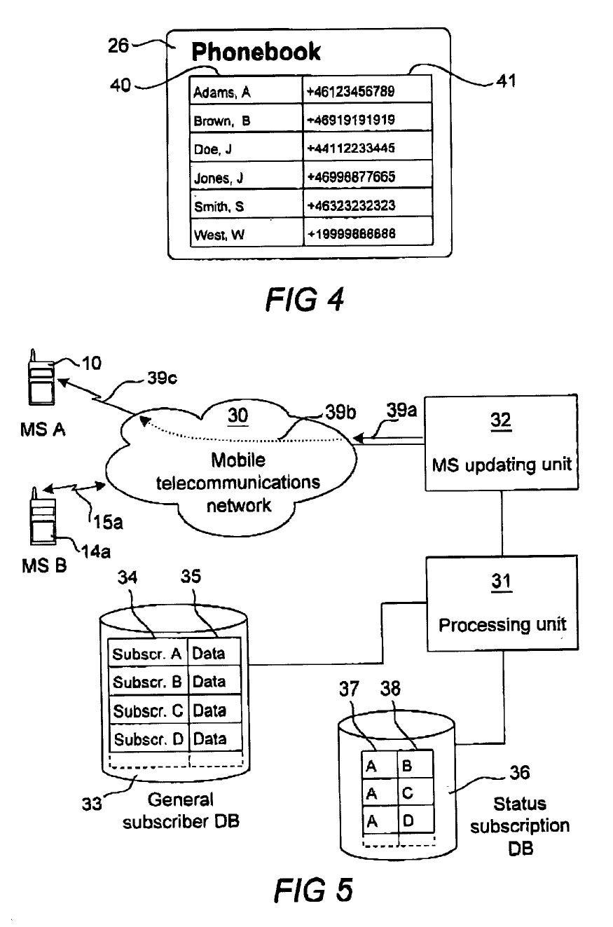

The memory 45 in also adapted to store an electronic phonebook 45c for keeping track of other telephone users and their associated telephone numbers. FIG. 4 illustrates a conventional phonebook, when presented on the display of a mobile telephone. As appears from FIG. 4, a conventional phonebook comprises a plurality of names 40 or similar information for identifying the different telephone users as well as a corresponding set of associated telephone numbers 41. The user 49 will typically access the phonebook through the keypad 28/46 and the display 26/47 when trying to place a telephone call to another user listed in the phonebook. As already described, however, it is far from guaranteed, that the called user is actually available for answering the call at the moment.

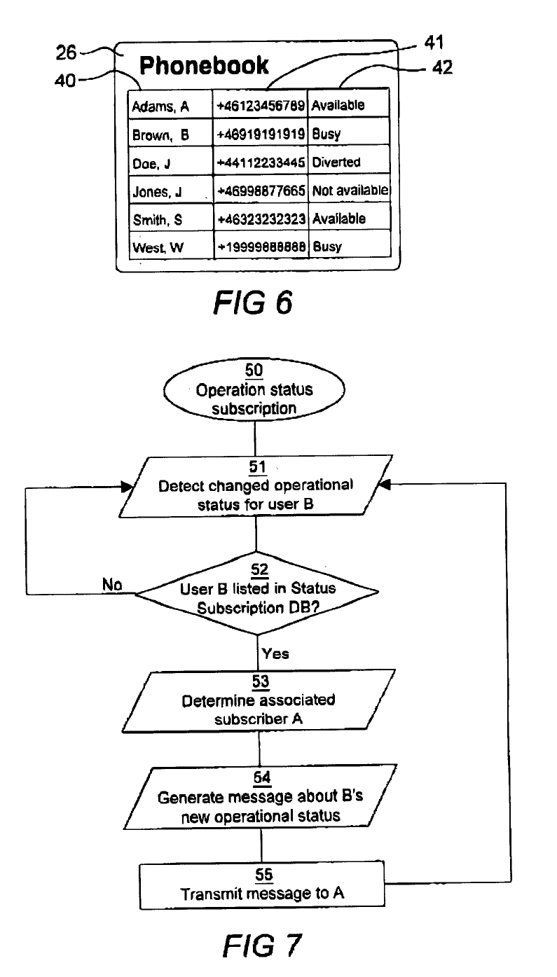

According to the preferred embodiment, the phonebook of FIG. 4 is extended, as shown in FIG. 6, to contain also a set of data fields or tags 42, which inform the user 49 of the momentary availability of the different users 40 listed in the phonebook. The status information 42 may indicate that the associated user 40 is currently available for answering a telephone call from the user 49 (“Available”). In other words, the status “Available” represents a situation, where the associated user 40 is currently not participating in any ongoing telephone call within the mobile telecommunications system but has nevertheless operative access to the system.

The status information 42 may also indicate that the associated user 40 is currently participating in an ongoing telephone call within the mobile telecommunications system and is therefore not available for answering an incoming telephone call at the moment (“Busy”). Moreover, the status information 41 may indicate that the associated user 40 is currently not operatively accessible, i.e. is currently not within reach of the mobile telecommunications system (“Not available”). Additionally, the status information 42 may indicate that the associated user 40 is currently using call diversion (“Diverted”). However, the status information 42 may also represent other situations than the ones given above.

The status information shown in column 42 of the phonebook in FIG. 6 is received from the mobile telecommunications system through the radio link 11 and the radio interface 24, 43 of the mobile telephone 10. An outline of the mobile telecommunications system according to the preferred embodiment is given in FIG. 5. Reference numeral 30 commonly represents the mobile telecommunications network shown in FIG. 1, i.e. the different base transceiver stations 12a-b, 16a-b, the base station controllers 13, 17, the switching center 18, and the home and visitor databases 19, 20. The mobile telecommunications system also comprises a processing unit 31 and a mobile station updating unit 32, both of which may be implemented by any appropriate electronic logic device(s), in combination with an appropriate set of software routines. For instance, the processing unit 31 and the updating unit 32 may be implemented in software, which is read and executed by any commercially available computer. The mobile telecommunications system of FIG. 5 also comprises a general subscriber database 33, which keeps record of the different users or subscribers 34 of the mobile telecommunications system. As appears from FIG. 5, the general subscriber database comprises a list of subscribers A-D (34) as well as associated data 35 for each subscriber. The general subscriber database 33 is connected to the processing unit 31.

The mobile telecommunications system moreover comprises a status subscription database 36, which also is connected to the processing unit 31 and the purpose of which will be described below.

In the mobile telecommunications system shown in FIG. 5, an individual user, such as one of the subscribers A-D listed in the general subscriber database 33, may choose to “subscribe” to online information about the current operational status of any of the other users (subscribers A-D) of the mobile telecommunications system. As has already been described above, this status information will be presented as an additional data field or tag 42 in association with the particular user 40 and his/her telephone number 41 in the phonebook shown in FIG. 6.

FIG. 5 illustrates a simplified and exemplifying situation, where the user A of the mobile telephone 10 has chosen to subscribe to status information concerning the other subscribers B, C and D listed in the general subscriber database 33. As appears from FIG 5, the status subscription database 36 therefore contains one record each for these three individual subscriptions. The status subscription database 36 contains a first record, where the subscriber A (column 37) is linked to the subscriber B (column 38). Correspondingly, in a second record the subscriber A is linked to the subscriber C, and in a third record subscriber A is linked to subscriber D. The user A may place his/her subscription in any of several different ways. For instance, the user A may simply call a helpdesk or subscription department at the mobile telecommunications system operator and place his/her subscription manually. Alternatively, the user A may place his subscription through a website on the Internet, by sending an e-mail to the operator, etc. If the mobile telephone 10 is provided with a WAP (“Wireless Application Protocol”) client, the user A may place his subscription through a WAP connection to a WAP service provided by the mobile telecommunications system operator.

The operation of the system shown in FIG. 5 will now be explained further. Assuming initially that the user B is currently not using his/her mobile telephone 14a but has switched off the telephone, there will currently be no operative link 15a between the mobile telephone 14a and the mobile telecommunications network 30. The processing unit 31 is adapted to perform a check, on a regular basis, concerning the operational status of the various users 38 listed in the status subscription database 36. Consequently, the processing unit 31 will determine that the user B is not operatively available at the moment and generate a digital message, having this meaning and being intended for the user A of the mobile telephone 10. The digital message is delivered to the mobile station updating unit 32, which forwards the message through the mobile telecommunications network via a wireless link to the mobile telephone 10, as is indicated by arrows 39a-c in FIG. 5. Once the digital message is received by the mobile telephone 10, the controller 44 will extract the information contained in the message and update the related data field or tag 42 in the phonebook 45c, which is presented on the display 26 (see FIG. 6). In the situation described above, the current status for user B will be “Not available”.

Assuming then that the user B switches on his/her mobile telephone 14a and establishes a link 15a to the mobile telecommunications network 30, this will be detected by the processing unit 31, which performs a first check in the status subscription database 36 to find out whether the operational status of subscriber B is subscribed to by anyone. As shown in FIG. 5, user A has placed a subscription for operational status information concerning user B; therefore the processing unit 31 will form a digital message, similar to the one described above, containing the new status information about subscriber B. This digital message is forwarded to the mobile station updating unit 32, which will transmit the digital message through the links 39a-c to the mobile station 10. In response, the controller 44 of the mobile telephone 10 will update the data field or tag 42 of user B in the phonebook of FIG. 6, so that the value thereof will change from “Not available” to “Available”.

Similarly, whenever the operational status of user B changes, the processing unit 31 of the mobile telecommunication system shown in FIG. 5 will detect this and form a digital message to be transmitted to the user A through the mobile station updating unit 32 and the mobile telecommunications network 30.

The digital message transmitted by the processing unit 31 and the mobile station updating unit 32 through the links 39a-c and the mobile telecommunications network 30 to the mobile telephone 10 may for instance be a short text message, such as an SMS message in GSM or an MMS message (“Multimedia Messaging Service”) in UMTS (“Universal Mobile Telephone System”). Alternatively, the digital message may be transmitted over a digital data channel through the mobile telecommunications network 30, such as a USSD (“Unstructured supplementary Service Data”) channel in GSM, or by means of another data carrier, such as a GPRS (“General Packet Radio Service”) network. Yet another alternative, provided that the mobile telephone 10 is equipped with appropriate WAP functionality, is to push the digital message as a WAP message to the mobile telephone 10 through the mobile telecommunications network 30. The message may also be communicated across a similar interface for accessing the Internet or another global area network.

FIG. 7 illustrates a flow chart, which explains, in a simplified manner, how the processing unit 31 operates in order to provide the subscribed operational status information about user B to the user A of the mobile telephone 10. In a first step 50, various initializing measures are performed. Then, in a step 51 the processing unit 31 is notified, from the mobile telecommunications network 30, that there has been a change in operational statue of the user B at his/her mobile telephone 14a.

In a subsequent step 52, the processing unit 31 checks whether user B is listed in the status subscription database 36. If this is not the case, the execution is returned to step 51. Otherwise, the execution continues to a step 53, where the processing unit 31 determines which user (A) that has placed a subscription for user B in the status subscription database 36. The processing unit 31 also consults the general subscriber database 33 in order to find out necessary information about user A, in order to be able to send the changed status information to his/her mobile telephone 10. Then, in a step 54, the processing unit 31 forms the digital message, which contains information about the new operational status of user B. This digital message is forwarded, as has been described above, to the mobile station updating unit 32 in a subsequent step S5, wherein the updating unit 32 will transmit the digital message through the links 39a-c and the mobile telecommunications network 30 to the mobile telephone 10. After completion of step 55, the control is returned to the beginning of step 51.

The mobile telephone 10 may be provided with an additional feature according to a further development of the preferred embodiment of the invention. Particularly as regards operational status “Available”, the mobile telephone 10 may be arranged, in addition to displaying the operational status as a data field or tag 42 in the phonebook (see FIG. 6), to also give another indication to the user 49. This additional indication may be a visual indication through an indication lamp or light emitting diode on the mobile telephone 10 (not shown in FIG. 2), a graphic alert on the display 26/47, an acoustic notice through the loudspeaker 25, or a vibrating signal through a vibrator inside the mobile telephone 10 (not shown in FIG. 2).

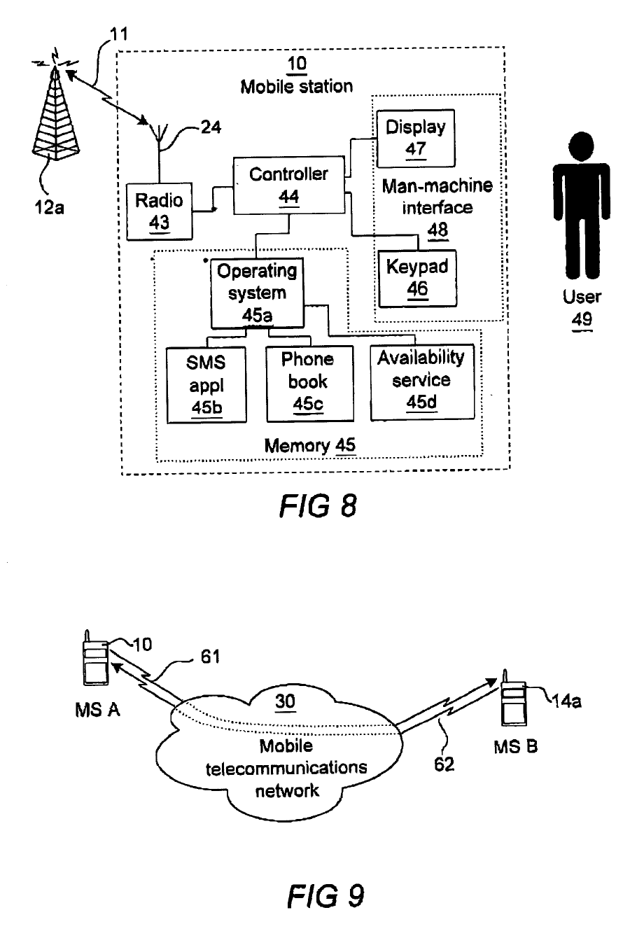

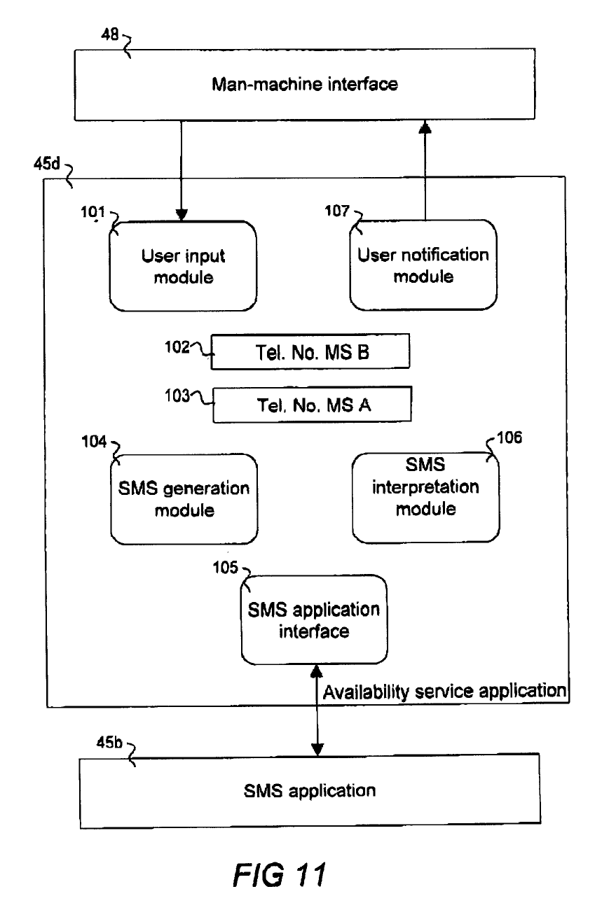

An alternative embodiment of the invention will now be described with reference to FIGS. 8-11. As seen in FIG. 8, in addition to the preferred embodiment of FIG. 3, the alternative embodiment involves an availability service application 45d, which is illustrated in more detail in FIG. 11 and which will be described in more detail in the following. In summary, the purpose of the availability service application 45d is to provide the user 49 of the mobile telephone 10 (MS A) with operational status information regarding another mobile telephone 14a (MS B) by communicating digital messages directly between the two mobile telephones without having to rely on operational status information registered in the mobile telecommunications network 30 itself. These digital messages between the mobile telephone 10 and the mobile telephone 14a are indicated as 61 and 62 in FIG. 9. In the alternative embodiment, the mobile telecommunications network 30 is a GSM network, and the digital messages 61, 62 may advantageously be communicated as class 2 SMS messages. However, the mobile telecommunications network 30 may be of another type than GSM, for instance GPRS or UMTS. In the latter case, the digital messages 61, 62 may be MMS messages.

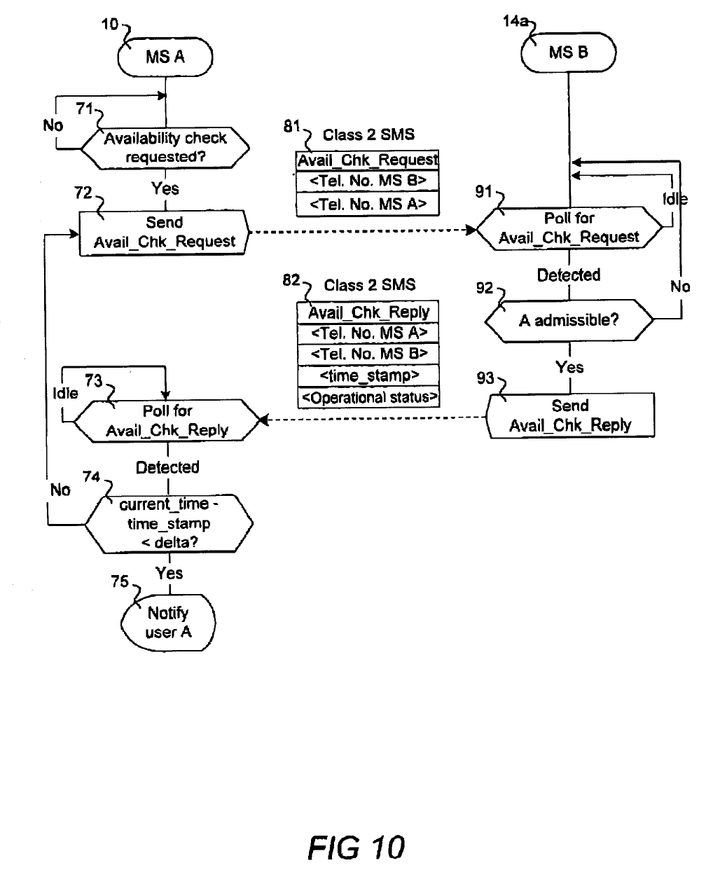

With reference to FIG. 10, whenever the user 49 of the mobile telephone 10 (MS A) wants to determine the momentary operational status of the second mobile telephone 14a (MS B) the user 49 will invoke the availability service application 45d of FIGS. 8 and 11, which will carry out a sequence of actions necessary for determining the operational status of MS B. To this end, the user 49 invokes the availability service application through the man-machine interface 48 of MS A. For instance, the user 49 may select an option in a menu system presented on the display 47 by pressing a certain key on the keypad 46.

The availability service application 45d has a user input module 101, which is responsible for receiving the availability service invocation from the user 49. As seen in FIG. 10, once the user input module 101 of the availability service application 45d has received the invocation in a step 71, the availability service application 45d will continue to a step 72, where an SMS generation module 104 will generate a first SMS message 81 of class 2. The first SMS message 81 contains a request for availability check, Avail_Chk_Request, followed by the telephone number of the intended receiver, i.e. MS B, as well as the telephone number of the requestor, i.e. MS A. The latter telephone number is available in a record 103 in memory 45 of the mobile station 10 (MS A). The first telephone number, i.e. that of MS B, may also have been stored, at an earlier moment, in a record 102 in the memory 45 by the user 49. Alternatively, the user 49 may enter the telephone number of MS B in step 71 on the keypad 46 of the man-machine interface 48 through the user input module 101. Then, step 72 is finished by sending the generated first SMS message 81 through an SMS application interface 105 of the availability service application 45d, which cooperates with the SMS application 45b.

Concurrently, the second mobile telephone 14a (MS B) will poll for incoming availability check requests in a step 91. To this end, MS B has its own instance of the availability service application 45d and also a man-machine interface 48 as well as an SMS application 45b. When the first SMS message 81 has been received in step 91 by MS B, through the SMS application interface 105, an SMS interpretation module 106 in MS B will preferably check (in a step 92) whether the sender of the SMS message 81, i.e. MS A, is admissible when it comes to requesting operational status from MS B. In other words, the user of MS B will preferably have an opportunity to prevent other users, including user 49 of MS A, from obtaining operational status information from MS B. This may be implemented by storing a list of admissible users in the memory 45 of MS B.

If it is determined in step 92 that MS A is not admitted to request operational status from MS B, the execution will be returned to the polling step 91. Otherwise, the execution will continue to a step 93 in MS B, where the SMS generation module 104 of MS B will create a second SMS message 82 of class 2. As seen in FIG. 10, the second SMS message 82 will contain a reply header, Avail_Chk_Reply, and moreover the telephone number of the intended receiver, i.e. MS A, as well as the telephone number of the sender, i.e. MS B. Additionally, the second SMS message 82 will contain a time stamp representing the actual time and date at which the second SMS message 82 was generated by MS B. In order to avoid problems with different time zones, the time stamp may advantageously be expressed using the Internet time format. Finally, the second SMS message 82 contains an indication of the current operational status of MS B. In similarity with the preferred embodiment, the operational status may be “Available”, indicating that MS B is connected to the telecommunications network 30 and is not involved in an ongoing telephone call. Moreover, the operational status of MS B may be that MS 8 is connected to the telecommunications network 30 but is currently involved in an ongoing telephone call (“Busy”). If MS B is currently involved in call diversion or call forwarding, the operational status may be “Diverted” or “Call forward”.

Step 93 in MS B is ended by having the SMS application interface 105 thereof sending the second SMS message 82 through the SMS application 45b and the telecommunications network 30 to MS A. In MS A, its SMS interpretation module 106 together with the SMS application interface 105 poll for availability check reply messages from MS B. Once the second SMS message 82 has been detected in step 73 in MS A, the SMS interpretation module 106 evaluates the received SMS message in a step 74. Here, the time stamp from MS B is compared to the current time. If the difference is less than a predetermined limit delta, where delta is a time which is defined with respect to expected latency in the telecommunications network 30, the MS A interprets the reply message 82 as being valid and, therefore, trusts the operational status indicated therein. The SMS interpretation module 106 of MS A commands a user notification module 107 to notify the user 49 of the operational status of MS B in a step 75. The user notification module 107 performs the user notification through the man-machine interface 48 of MS A. Preferably, the notification may be submitted as an icon or text message on the display 47 (e.g., “Subscriber <Tel. No. MS B> is Available”. Alternatively, the user notification may be performed through an indication lamp on the mobile telephone 10, through an audible signal or message, for instance a prestored vocal message, through the loudspeaker 25, or through a vibrator.

If, on the other hand, it is determined by the SMS interpretation module 106 of MS A in step 74 that the difference between the current time and the time stamp in the received reply SMS message 82 exceeds the predetermined limit delta, MS A cannot crust the validity of the SMS message 82, since there is a risk that MS A has been turned off in the meantime. In this situation, the execution returns to step 72, wherein a new availability check request message 81 is generated and sent to MS B.

In the alternative embodiment described above, the components 101-107 of the availability service application 45d are all implemented as pieces of software code, which may be read and executed by the controller 44 in the operating system 45a. However, all or some of these components may alternatively be implemented in hardware. Moreover, SMS message are used for the availability check request and availability check reply messages 81 and 82 in the alternative embodiment. However, other forms of digital messages may be used, for instance MMS messages or messages that are communicated via WAP or e-mail.

The present invention has been described above with reference to a few exemplifying embodiments. However, other embodiments than the ones disclosed herein are equally possible within the scope of the invention, as defined by the appended independent patent claims.

1. A telecommunication apparatus (10) having a radio interface (24, 43), a controller (44), a memory (45), an input device (46) and an output device (47), the controller being arranged to provide a man-machine interface (48) to a user (49) through the input and output devices, the memory comprising a phonebook (40-42) capable of storing a plurality of phonebook entries, each entry representing a respective subscriber and an associated telephone number, the phonebook being accessible through the man-machine interface, characterized in that
the phonebook (40-42) is capable of storing, for at least one of the phonebook entries, information (42) about an operational status of a respective subscriber; and
the controller (44) is adapted to update the operational status information of the at least one phonebook entry in response to status data, which are received through the radio interface (24, 43).

2. A telecommunication apparatus as in claim 1, wherein the operational status information may represent a situation, where the respective subscriber is currently participating in an ongoing telephone call (“Busy”).

3. A telecommunication apparatus as in claim 1 or 2, wherein the operational status information may represent a situation, where the respective subscriber is currently not participating in any ongoing telephone call and is operatively accessible (“Available”).

4. A telecommunication apparatus as in claim 3, wherein the controller (44) is adapted, in response to receiving status data to the effect that the situation in claim 3 has occurred, to provide an indication to the user through the output device (47).

5. A telecommunication apparatus as in claim 4, wherein the output device (47) is a display, an indication lamp, a loudspeaker (25) or a vibrator.

6. A telecommunication apparatus as in any preceding claim, wherein the operational status information may represent a situation, where the respective subscriber is not operatively accessible (“Not available”).

7. A telecommunication apparatus as in any preceding claim, wherein the operational status information may represent a situation, where the respective subscriber is currently using call diversion (“Diverted”).

8. A telecommunication apparatus as in any preceding claim, wherein the telecommunication apparatus is a mobile telephone.

9. A telecommunication apparatus as in any preceding claim, wherein the radio interface (24, 43) is adapted to receive short text messages, such as SMS (“Short Messages Services”) or MMs (“Multimedia Messaging Service”) messages, and wherein the status data is comprised in such a short text message.

10. A telecommunication apparatus as in any preceding claim, wherein the radio interface (24, 43) is adapted to receive the status data on a data channel in a digital telecommunications system, such as a USSD (“Unstructured Supplementary Service Data”) channel in a GSM (“Global System for Mobile communication”) system.

11. A telecommunication apparatus as in any preceding claim, wherein the radio interface (24, 43) is adapted to receive the status data over a GSM, GPRS (“General Packet Radio Service”) or UMTS (“Universal Mobile Telephone System”) network.

12. A telecommunication apparatus as in any preceding claim, further comprising functionality for accessing a global area network, such as the Internet, wherein the status data is received over said global area network.

13. A telecommunication apparatus as in claim 12, further comprising a WAP (“Wireless Application Protocol”) client, by means of which the status data is received.

14. A method of operating a telecommunications network (30) involving a plurality of subscribers of mobile telecommunications services, characterized by the steps of:
providing an option for an individual subscriber to select at least one other subscriber,
keeping record of the selected subscriber,
determining an operational status of the selected subscriber, and
transmitting the determined operational status to the individual subscriber.

15. A method as in claim 14, wherein the operational status may reflect any of the following situations the respective subscriber is participating in an ongoing telephone call (“Busy”); the respective subscriber is not participating in any ongoing telephone call and is operatively accessible to the telecommunications network (30) (“Available”); the respective subscriber is not operatively accessible to the telecommunications network (“Not available”); or the respective subscriber is currently using call diversion (“Diverted”).

16. A method as in claim 14 or 15, wherein the determined operational status is transmitted in a short text message, such as an SMS or MMS message.

17. A method as in claim 14 or 15, wherein the determined operational status is transmitted over a data channel in a digital telecommunications system, such as a USSD channel in a GSM system.

18. A method as in claim 14 or 15, wherein the determined operational status is transmitted according to a communications protocol, such as WAP for accessing a global area network, such as the Internet.

19. A method as in claim 14 or 15, wherein the determined operational status is transmitted over a GPRS or UMTS network.

20. A telecommunication apparatus (10) for use in a telecommunications network (30), the apparatus having a radio interface (24, 43), a controller (44), a memory (45), a man-machine interface (48) to a user (49) of the telecommunication apparatus, and a digital message service application (45b) capable of communicating a digital message (81) to a remote telecommunication apparatus (14a) through the radio interface (24, 43) and the telecommunications network (30), characterized by
first means (101) for receiving a request (71) to check an operational status of the remote telecommunication apparatus (14a), said request being submitted by the user (49) through the man-machine interface (48);
second means (101) for reading a first record (102) to identify the remote telecommunication apparatus;
third means (104) for generating a first digital message (81), wherein said first digital message contains said first record as well as a second record (103) to identify said telecommunication apparatus (10);
fourth means (105) for causing the digital message service application (45b) to send said first digital message to the remote telecommunication apparatus;
fifth means (105) for receiving a second digital message (82) from the remote telecommunication apparatus;
sixth means (106) for determining the operational status of the remote telecommunication apparatus from the second digital message; and
seventh means (107) for indicating the determined operational status of the remote telecommunication apparatus to said user through the man-machine interface.

21. A telecommunication apparatus as in claim 20, wherein the second digital message (82) is a reply to the first digital message and contains a data field to indicate that the remote telecommunication apparatus (14a) is connected to the telecommunications network (30).

22. A telecommunication apparatus as in claim 21, wherein said data field indicates that the remote telecommunication apparatus (14a) is involved in an ongoing telephone call (“Busy”).

23. A telecommunication apparatus as in claim 21, wherein said data field indicates that the remote telecommunication apparatus (14a) is not involved in an ongoing telephone call and is therefore operatively accessible (“Available”).

24. A telecommunication apparatus as in any of claims 20-23, wherein said first record (102) represents a telephone number of the telecommunication apparatus (10).

25. A telecommunication apparatus as in any of claims 20-24, wherein said second record (103) represents a telephone number of the remote telecommunication apparatus (14a).

26. A telecommunication apparatus as in any of claims 20-25, wherein said seventh means (107) is adapted to provide the indication of the determined operational status of the remote telecommunication apparatus (14a) to said user (49) through a display (26, 47), an indication lamp, a loudspeaker (25) or a vibrator.

27. A telecommunication apparatus as in claim 21, wherein said data field indicates that the remote telecommunication apparatus (14a) is involved in call diversion (“Diverted”) or call forwarding (“Call forward”).

28. A telecommunication apparatus according to any of claims 20-27, wherein the telecommunication apparatus is a mobile telephone.

29. A telecommunication apparatus as in any of claims 20-28, wherein said first digital message (81) and said second digital message (82) are short text messages, such ea SMS or MMS.

30. A telecommunication apparatus as in any of claims 20-28, wherein said first digital message (81) and said second digital message (82) are transferred over a GPRS or UMTS network.

31. A method of communicating operational status information between a first telecommunication apparatus (10) and a second telecommunication apparatus (14a) in a telecommunications network (30), characterized by the steps of:
through a man-machine interface (48) of the first telecommunication apparatus (10), receiving (71) a request from a user (49) of the first telecommunication apparatus to check an operational statue of the second telecommunication apparatus (14a);
in response to receiving said request from said user, generating a first digital message (81);
sending (72) said first digital message to the second telecommunication apparatus;
receiving (91) said first digital message in said second telecommunication apparatus;
in said second telecommunication apparatus, generating a second digital message (82), containing an indication of the operational status of the second telecommunication apparatus;
sending (93) said second digital message to the first telecommunication apparatus;
receiving (73) said second digital message in the first telecommunication apparatus; and
in the first telecommunication apparatus, providing (75) a notification to said user concerning the operational status of the second telecommunication apparatus, as indicated in said second digital message.

32. A method according to claim 31, comprising the further step of checking (92), in the second telecommunication apparatus (14a), whether the first telecommunication apparatus (10) is an admissible requestor of operational status information regarding the second telecommunication apparatus.

33. A method according to claim 31 or 32, wherein said second digital message (82) comprises a time stamp representative of a creation time of said second digital message, the method comprising the further step of determining (74), in said first telecommunication apparatus (10), whether a difference between a current time and said time stamp is less than a predetermined limit and, if not,
sending (72) a new first digital message (81) to the second telecommunication apparatus (14a).

34. A method according to any of claims 31-33, wherein said step of providing (75) an indication to said user (49) of the operational status of the second telecommunication apparatus (14a) is done through a display (26, 47), an indication lamp, a loudspeaker (25) or a vibrator in the first telecommunication apparatus.
